(19) United States
(12) Patent Application Publication
(10) Pub. No.: US 2008/0238113 A1
(43) Pub. Date: Oct. 2, 2008

(54) Locking device for the closing lid of washing machines

(76) Inventor: Onofrio Ricchitelli, Pogliano Milanese (Milano) (IT)

Correspondence Address: JACOBSON HOLMAN PLLC, 400 SEVENTH STREET N.W., SUITE 600, WASHINGTON, DC, 20004, US

(21) Appl. No.: 12/076,749

(22) Filed: Mar. 21, 2008

(30) Foreign Application Priority Data
Mar. 26, 2007 (IT) MI 2007A 00601

(51) Int. Cl. E05C 19/00

(52) U.S. Cl. 292/302

(57) ABSTRACT

Locking device for the closing lid of a washing machine or the like, comprising an enclosure (1) housing a cursor (7) sliding between a holding position of the latch (5) mounted on the lid and a releasing position from the same, and an electromechanical delaying device (20) capable of locking said cursor (7) through a pawl (21) in a holding position. The cursor (7) is actuated by a second sliding cursor (6) subjected to the action of elastic means (8) and fitted with a portion (11) profiled to form a slope, which is capable of inducing a backward motion of the pawl (21) in case of a forced opening of the lid.

The present invention concerns a locking device for the closing lid of washing machines and the like.

The invention concerns in particular, while not to be understood in a limiting sense, front-loading washing machines.

The basket of front-loading washing machines is closed by a tightly sealing lid hinged to the front panel of the machine and fitted with a closing latch engaged by a locking device which is likewise mounted on the machine's front panel.

The locking device allows a snap closing of the lid, by engaging the latch when pressed against the panel of the machine, as well as its opening, after a certain delay, by disengaging the latch at the end of its operating cycle.

The locking device in fact houses the instantaneous locking and unlocking device of the lid, generally also known as lid locking device, whose function is to prevent the lid from opening after starting the machine, and to delay its opening once the operating cycle is over, so as to guarantee that the basket's inertial rotation runs out.

There are known devices realizing this function, where at the time of starting the machine, the lid locking device actuates a pawl capable of locking the sliding rod that engages the latch in the lid, thus preventing the lid from opening until the pawl has moved back.

It is further known that a lid locking device also fulfils the function of preventing the machine from starting up when the lid is open, thanks to the action of a micro-switch that authorizes actuating the machine only if the lid is closed. Thanks to this device, if the user tried to feed the machine with an open lid, the slide of the lid locking device, and consequently the closing of the machine actuating circuit would be inhibited by the very position of the sliding tod.

This type of devices suffers however from the drawback of being unable to interrupt the operating cycle in case it happened, during the machine's operation, that the pawl of the lid were accidentally extracted from its seat, for instance after the latch or the contact zone failed or because of their faulty scaling, with consequences undesirable und contrary to the most elementary safety rules.

The scope of the present invention is to realize a locking device for the closing lid of washing machines and the like, capable of overcoming the limitations and drawback of the prior art and in particular capable of not only mechanically preventing the start-up of the machine with an open lid, but also of allowing, during the machine's operating phase and in the event of a forced opening of the lid, to instantly open the actuating circuit and thus determine the immediate shutdown of the operating cycle.

According to the invention, these scopes are achieved by the locking device of the closing lid according to claim 1. Other advantageous characteristics are the object of dependent claims.

The invention will now be described with reference to the enclosed drawings that illustrate a preferred yet not limiting embodiment of the invention, wherein:

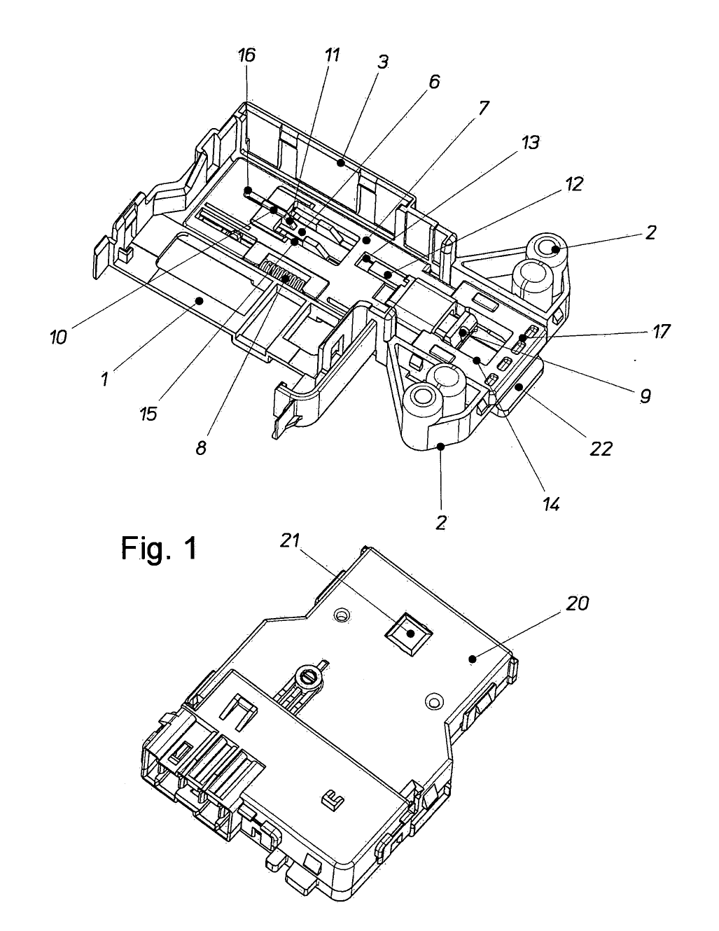

FIG. 1 is an axonometric view that shows the mechanical portion of the lid locking device according to the invention, as well as of the electromechanical delaying device.

FIG. 2 is a section of the lid locking device according to the invention, with the latch of the lid in an opened lid position;

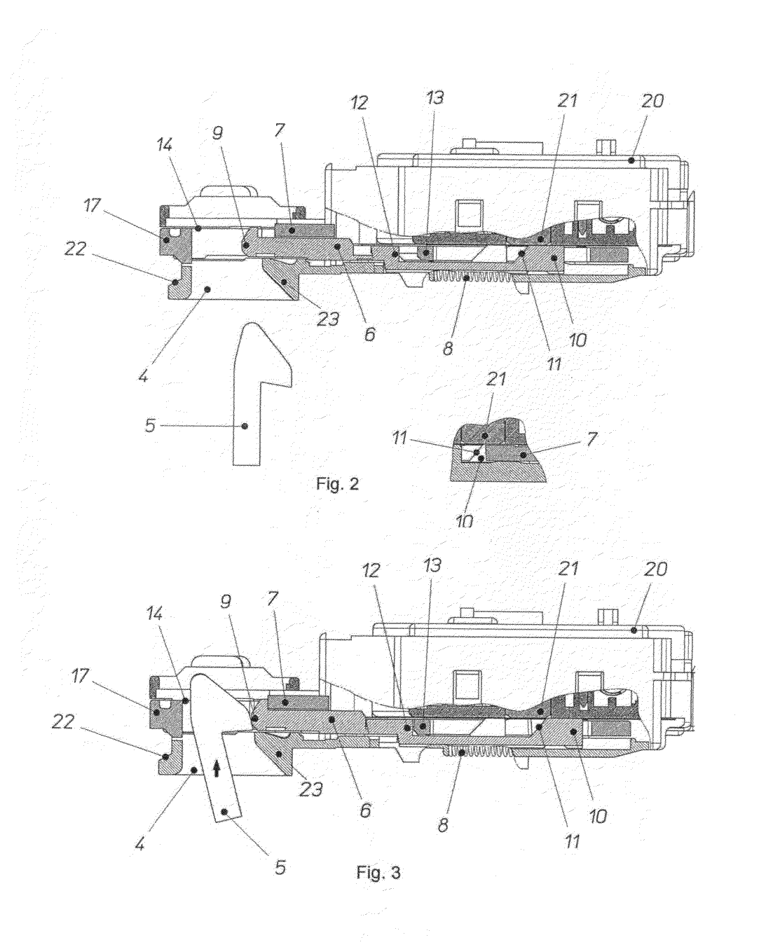

FIG. 3 is a section of the lid locking device according to the invention, with the latch of the lid in a closed lid position;

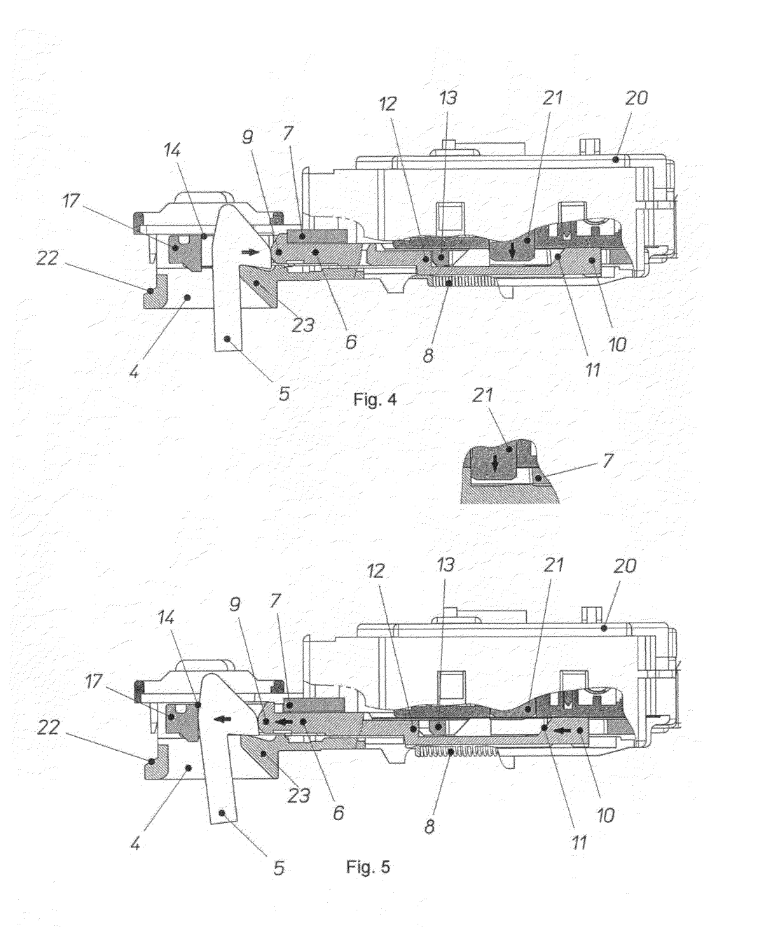

FIG. 4 is a section of the lid locking device according to the invention, with the latch of the lid in a closed and locked lid position;

FIG. 5 is a section of the lid locking device according to the invention, with the latch of the lid in a lid opening phase;

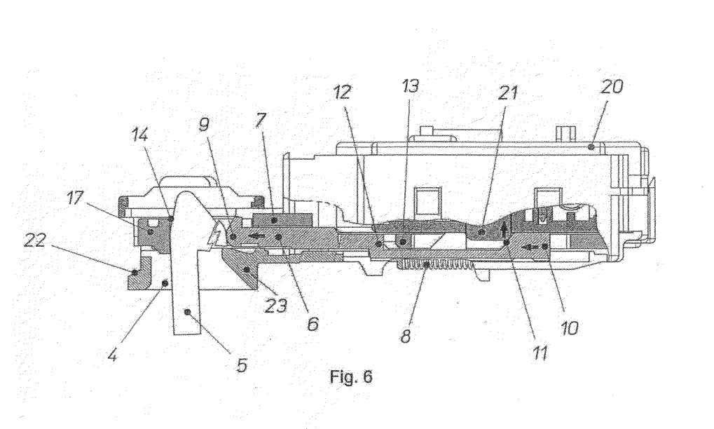

FIG. 6 is a section of the lid locking device according to the invention in forced opening phase of the latch of the lid during the operating cycle.

With reference to the FIGS. 1 and 2, the device according to the invention is formed by an enclosing body 1, preferably made of a thermoplastic material, which comprises a fastening portion 2 at the front panel of the washing machine and a portion 3 capable of housing an electromechanical delaying device 20.

The delaying device 20 is an electromechanical delaying device of a known type, fitted with a pawl 21 actuated by a thermal system, not shown in the figure, and connected to the actuating controls of the machine, such as for instance the mobile contact foil of a micro-switch mounted in series on one phase of the machine's actuating power source. It is fitted with terminals extending toward the inside in the form of quick-coupling contacts.

The fastening portion 2 has a rectangular opening 4 capable of receiving the latch 5 of the lid and a protruding frame 22 seated in the front panel of the machine, with the function of inviting and holding the latch.

The mechanical locking device of the latch 5 of the lid is constituted of two paired cursors 6 and 7 housed in the body 1 so as to be allowed to slide along its longitudinal axis.

The cursor 6 is subject to the action of a helical spring 8, which is also housed in the body 1. It is fitted with a profiled end 9 arranged across said longitudinal axis. In a resting position, meaning at an opened lid, the end 9 of the cursor 6 partially overlaps the opening 4.

The other end of the cursor 6 presents, on a plane parallel to the longitudinal axis, a tooth 10 with its internal face 7 profiled to form a slope. In a central position the cursor 6 is also fitted with a projection 12.

The cursor 7, which is profiled so as to allow coupling it to the cursor 6, has a window 13 capable of receiving the projection 12 of the cursor 6.

At the level of the opening 4 of the support 1, the end of the cursor 7 presents a rectangular opening 14 of a size corresponding to that of the opening 4, having an edge of increased thickness on the three outer sides and of reduced thickness on the inner side, meaning the side corresponding to the portion 23 of the frame 22, so as to receive the end 9 of the cursor 6. At its opposite the cursor 7 is fitted with a window 15, capable of receiving the locking pawl 21 actuated by the electromechanical delaying mechanism 21 that is arranged in line with a slit 16, which acts as a guide for the tooth 10 of the cursor 6.

The operation of the device according to the invention occurs as follows.

When the lid is open, the elements composing the device are held in the reciprocal positions shown in FIG. 2. The cursor 6 being subject to the action of the spring 8 is arranged with its end 9 overlapping the portion 23 of the frame 22 and partially overlapping the opening 4. The cursor 7, which is in turn pushed forward by the projection 12 of the cursor 12 to engage in the window 13, is arranged with its opening 14 set in line with the opening 4.

In this position, and as shown in the detail of FIG. 2, the cursor 7 prevents the sliding of the pawl 21 as the face 15 is not aligned with the same, thus preventing the actuating circuit to be closed, despite feeding power to the machine.

As shown by the FIGS. 3 and 4, when the lid is closed the latch 6 engages in the opening 4 and exerts, when rotating to a closing position while contacting the portion 23, a push on the end 9 of the cursor 6, thus causing it to slide in opposition to the action of the spring 8, which is thus subjected to a compressive action. The projection 12 of the cursor 6 in turn determines a backward motion of the cursor 7, which closes the opening 4 through the rim 17 of the opening 14. At the same time, the window 15 arranges itself in line with the axis of the pawl 21 of the lid locking device 20.

When the machine is put under power, the lid locking device is energized and triggers the pawl 21, that engages in the window 15 of the cursor 7 as shown in FIG. 4 so as to lock it in a position to hold the latch 5 of the lid, thus preventing the latch from rotating to the opening position for the entire duration of these conditions.

If at the moment of this situation, meaning when the lid is closed and locked, anyone should try to open the lid, the cursor 7 would prevent the rotation of the latch 5.

Under normal conditions, at the end of the operating cycle and in the ways already known, the locking pawl 21 moves back and disengages from the cursor 7. When rotating the latch 5 as shown in FIG. 5 and extracting it from the opening 4 to realize the opening of the lid, the cursor 6 acts, under the push of the elastic means 8, to actuate the cursor 7 through the projection 12 and to return the elements of the device to their respective positions shown in FIG. 2.

Should it on the other hand, during the operating cycle, accidentally happen that the latch 5 of the lid is extracted from the opening 4, for instance if the latch or the contact zone fails or their scaling is faulty, the cursor 6 would, as shown in FIG. 6, under the effect of the force of the spring 8 shift to a resting position, and at the same time, by acting on the pawl 21 through the portion 11 of the tooth 10 profiled as a slope, cause the same to be retracted and the actuating circuit of the machine to be instantly opened.

The elements of the device would thus be rearranged to their respective positions shown in FIG. 2.

The invention has been illustrated with reference to preferred constructions, but is generally susceptible to other applications and modifications that are intended as being included in the range of protection, as will be evident to a specialist in the branch.

1. A locking device for the closing lid of a washing machine and the like, comprising an enclosure housing a cursor sliding between a holding position of the latch mounted on the lid and a position releasing it from the same, and an electromechanical delaying device capable of locking said cursor through a pawl in a holding position while said electromechanical delaying device is electrically connected to the actuating controls of the machine, characterized by the fact that said cursor is coupled to a second sliding cursor subjected to the action of elastic means and fitted with a portion capable of causing a backward motion of the pawl.

2. The locking device according to claim 1, characterized by the fact that the portion of cursor presents a face profiled to form a slope.

3. The locking device according to claim 2, characterized by the fact that the cursor has a profiled end arranged to match the portion of the device capable of receiving the latch of the lid.

4. The locking device according to claim 3, characterized by the fact that the portion of cursor has an end fitted with a rectangular opening with a lower rim of a thickness capable of receiving the end of the cursor.

5. The locking device according to claim 1, characterized by the fact that said cursors and are coupled to each other by a projection and a seat.

6. The locking device according to claim 2, characterized by the fact that the cursor is fitted with a slit suitable for guiding the portion of the cursor that communicates with the window capable of receiving the pawl.
